(19) United States
(12) Patent Application Publication
(10) Pub. No.: US 2014/0279256 A1
(43) Pub. Date: Sep. 18, 2014

(54) LOCAL PRODUCT SEARCH BASED ON PHOTO SHARING SERVICE ACTIONS

(71) Applicant: Jeremiah Joseph Akin, Pleasant Hill, CA (US)

(72) Inventor: Jeremiah Joseph Akin, Pleasant Hill, CA (US)

(73) Assignee: eBay Inc., San Jose, CA (US)

(21) Appl. No.: 13/874,157

(22) Filed: Apr. 30, 2013

Related U.S. Application Data
(60) Provisional application No. 61/798,782, filed on Mar. 15, 2013.

(51) Int. Cl. G06Q 30/06; G06K 9/00

(52) U.S. Cl. CPC G06Q 30/0639; G06K 9/00536
USPC 705/26.62

(57) ABSTRACT

Information about user actions with respect to one or more photos on a photo sharing service may be received. A user intent regarding a first of the one or more photos may be determined. A product in the first of the one or more photos may be identified, and the product may be matched to a further product on a local search service. A local search may be performed on the matched product on the local search service, to locate one or more stores local to a user's current location that have the matched product in stock. The results from the local search may be displayed to a user.

### TECHNICAL FIELD

This application relates generally to photo sharing services. More particularly, this application relates to locating local products based on actions on photo sharing services.

### BACKGROUND

The ever increasing use of smart phones, such as the iPhone® (from Apple Inc. of Cupertino, Calif.), with data connections and location determination capabilities is slowly changing the way people shop for products and services and share their interests. One recent trend is the increase in popularity of photo sharing services, such as Pinterest™. On such photo sharing services, users identify photos of interest. In the case of Pinterest™, users tag photos (e.g., photos of items) found on other websites. Other users may then view the user's tagged photos and tag the photos themselves for their own collection. These tagged photos often include link information identifying the source of the photos (such as a website that the photo was found on). Sometimes these sites sell items depicted in the photos, but other times, there is no corresponding item for sale on the source site.

### BRIEF DESCRIPTION OF DRAWINGS

FIG. 1 is a network diagram depicting a client-server system, within which one example embodiment may be deployed.

FIG. 2 is a block diagram illustrating marketplace and payment applications that, in one example embodiment, are provided as part of the networked system of FIG. 1.

FIG. 3 is a diagram illustrating a system, in accordance with an example embodiment.

FIG. 4 depicts a flow diagram illustrating a method of finding a product of interest at a local store, in accordance with an example embodiment.

FIG. 5 is a block diagram of a machine in the form of a computer system within which a set of instructions may be executed for causing the machine to perform any one or more of the methodologies discussed herein.

### DETAILED DESCRIPTION

The description that follows includes illustrative systems, methods, techniques, instruction sequences, and machine-readable media (e.g., computing machine program products) that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In an example embodiment, usage information from a photo sharing service is used to determine products of interest for a user. A local search service is then used to locate local stores carrying the products of interest, and alert the user when the user is in the vicinity of the local stores carrying the products of interest.

Discussed in this document is a photo sharing service. Such a photo sharing service provides users with the ability to identify photos of interest. In some instances, these photos are of products (or have products in them). One example of a photo sharing system is Pinterest™. A photo sharing service may be accessed using a web browser on a traditional computer or a smartphone, via a direct application, or even through a third-party application via an Application Program Interface (API).

Also discussed in this document is a local search system. Such a local search system provides for searches for items available in a particular region such as items within a certain radius of a user's current location. One example of a local search system is Milo™. A local search system may be accessed using a web browser on a traditional computer or smartphone, via a direct application, or even through a third-party application via an API. Another example of a local search system is Where.com™.

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective devices 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

FIG. 2 is a block diagram illustrating marketplace and payment applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions, etc.). The various auction applications 202 may also provide a number of features in support of such auction-format listings, such as a reserve price feature whereby a seller may specify a reserve price in connection with a listing, and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic, or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

FIG. 3 is a diagram illustrating a system 300, in accordance with an example embodiment. Included in the system 300 is a user intent module 302. The user intent module 302 includes a mechanism to determine user intent (e.g., of a user) surrounding actions taken (e.g., by the user) on a photo sharing service. This may be as simple as identifying photos that have been labeled as being of interest (such as pinned or tagged photos), or may include more detailed analysis, such as examining how much time a user spent viewing a particular photo, how many times the photo was viewed, how many times the photo was shared or emailed, or other actions taken on the photo sharing site that may evidence a strong interest in the photo.

A product identification module 304 may then identify products in photos of interest. This may include examining metadata of the file storing the photo, the metadata identifying the product by, for example, product name, manufacturer, Universal Product Code (UPC) code, catalog entry, and the like. In some example embodiments, the product identification may utilize image recognition to compare the item in the photo with a database of known product images. Other mechanisms of identifying the product within the photo are also contemplated, such as prompting a user to provide input as to the identification of the product.

A map module 306 may maintain a list of stores having the specific product in stock, along with the price and a location of the store.

A local search interface 308 interfaces with a local search system, such as Milo™, to perform various searches and matches, as will be described in more detail below.

A login module 310 manages a user's account and permits the user to log into the account using credentials, such as a user name and password.

A geolocation module 312 maintains current information about the user's location. This may include, for example, accessing a global positioning system (GPS) hardware device for information that can be translated into a location of the user.

An alerts notification module 314 may notify a user, based on geolocation, of stores potentially holding a required product in stock. For example, the user may be provided with a notification that references the user's current location and nearby stores that currently stock the product. The alerts notification module 314 can leverage store open hours data as well as user movement information to determine which products to notify the user about.

A display module 316 displays result information to a user.

FIG. 4 depicts a flow diagram illustrating a method 400 of finding a product of interest at a local store, in accordance with an example embodiment. At 402, information about user actions with respect to one or more photos on a photo sharing service is retrieved from the photo sharing service. At 404, a user intent regarding a first of the one or more photos is determined. At 406, a product in the first of the one or more photos is identified. At 408, the product is matched to a product on a local search service. At 410, a local search on the matched product is performed on the local search service in order to locate one or more stores local to a user's current location that have the matched product in stock. For example, the performing of this local search may include identifying the matched product to the local search service (e.g., by providing an identifier of the matched product), and obtaining the location of such a local store that has the matched product in stock. The location may be obtained from the local search service. At 412, results from the local search are displayed to a user.

It should be noted that in some example embodiments the photo sharing service may be affiliated with the local search service, while in other example embodiments the photo sharing service may be a completely separate entity.

As an example, a woman may have a bowl shaped like an avocado ‘pinned’ on her photo sharing service account. She also has a local search service application installed on her smartphone and linked to her photo sharing service account. When she is out on errands one day, her phone notifies her that a store close by has a bowl that is similar to the one that she has pinned on her photo sharing service account. The woman goes into the local store, decides she likes the bowl, purchases it, and takes it home. In this situation, the pinning of the photo is indicative of the woman's user intent (e.g., her interest in bowls similar to her avocado-shaped bowl).

In another example, a woman does not know what to get her friend for his birthday. She is connected to him on the photo sharing service, so she connects the local search service application on her phone with her friend's photo sharing service board. This occurs a couple of weeks before his birthday. A week later, she is walking past a shop that has a prop similar to a prop that her friend has previously admired (e.g., “liked”) on his photo sharing service board. In this situation, the friend's admiration of the prop is indicative of his user intent (e.g., his interest in a prop).

In another example embodiment, the user intent information may be further enriched by assigning different weights to different types of user actions. For example, sharing a photo may be weighted very strongly as showing a high interest in a photo, whereas merely viewing the photo may be weighted less strongly. In some example embodiments, a machine learning algorithm may be applied to the weights to dynamically adjust the weights based on learned behavior, either over multiple users or behavior specific to one particular user. For example, the system may learn over time that one particular user has high interest in purchasing items from photos he or she has shared (based on, for example, sales history), and may then therefore adjust the weights for that user higher than other users when it comes to sharing photos.

FIG. 5 is a block diagram of a machine in the form of a computer system within which a set of instructions may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In one embodiment, the machine will be a server computer; however, in alternative embodiments, the machine may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a display unit 510, an alpha-numeric input device 512 (e.g., a keyboard), and a user interface (UI) navigation (e.g., cursor control) device 514 (e.g., a mouse). In one embodiment, the display unit 510, input device 512, and cursor control device 514 are a touch screen display. The computer system 500 may additionally include a storage device (e.g., drive unit) 516, a signal generation device 518 (e.g., a speaker), a network interface device 520, and one or more sensors (not pictured), such as a GPS sensor, compass, accelerometer, or other sensor.

The drive unit 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504 and/or within the processor 502 during execution thereof by the computer system 500, with the main memory 504 and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding, or carrying instructions for execution by the machine and that cause the machine to perform any one or more of the methodologies of the example embodiments, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a WAN, the Internet, mobile telephone networks, POTS networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. An apparatus comprising:
a processor,
a memory;
a geolocation module configured to determine a current location of a user;
a user intent module configured to:
retrieve, from a photo sharing system, information about user actions with respect to one or more photos on the photo sharing service; and
determine a user intent about the one or more photos from the user actions;
a product identification module configured to identify a product depicted in the one or more photos;
a local search interface configured to
match the product to a further product on a local search service; and
perform a local search on the matched product on the local search service, to locate one or more stores local to a user's current location that have the matched product in stock; and
a display module configured to display results from the local search to a user.

2. The apparatus of claim 1, wherein the actions with respect to one or more photos include pinning the one or more photos.

3. The apparatus of claim 1, wherein the actions with respect to one or more photos include spending a particular amount of time viewing the one or more photos.

4. The apparatus of claim 1, wherein the actions with respect to the one or more photos including viewing the one or more photos a particular number of times.

5. The apparatus of claim 1, wherein the actions with respect to the one or more photos include sharing the one or more photos.

6. The apparatus of claim 1, wherein the user intent module is further configured to:
determine types of one or more user actions based on the information about user actions;
weight the user actions based on type; and
wherein the determining a user intent is based on the weighted user actions.

7. The apparatus of claim 1, wherein the product identification module utilizes image recognition to match objects in the one or more photos to products.

8. The apparatus of claim 1, wherein the local search interface is further configured to utilize a mapping between objects in photos and a product in a database in matching the product to a further product on a local search service

9. A method comprising:
retrieving, from a photo sharing service, information about user actions with respect to one or more photos on the photo sharing service;
determining a user intent regarding a first of the one or more photos;
identifying a product in the first of the one or more photos;
matching the product to a further product on a local search service;
performing a local search on the matched product on the local search service, to locate one or more stores local to a user's current location that have the matched product in stock; and
displaying results from the local search to a user.

10. The method of claim 9, wherein the actions with respect to one or more photos include pinning the one or more photos.

11. The method of claim 9, wherein the actions with respect to one or more photos include spending a particular amount of time viewing the one or more photos.

12. The method of claim 9, wherein the actions with respect to the one or more photos including viewing the one or more photos a particular number of times.

13. The method of claim 9, wherein the actions with respect to the one or more photos include sharing the one or more photos.

14. The method of claim 9, further comprising:
determining types of one or more user actions based on the information about user actions;
weighting the user actions based on type; and
wherein the determining a user intent is based on the weighted user actions.

15. The method of claim 9, wherein the product identification module utilizes image recognition to match objects in the one or more photos to products.

16. A non-transitory machine-readable storage medium comprising a set of instructions which, when executed by a processor, causes execution of operations comprising:
retrieving, from a photo sharing service, information about user actions with respect to one or more photos on the photo sharing service;
determining a user intent regarding a first of the one or more photos;
identifying a product in the first of the one or more photos;
matching the product to a further product on a local search service;
performing a local search on the matched product on the local search service, to locate one or more stores local to a user's current location that have the matched product in stock; and
displaying results from the local search to a user.

17. The non-transitory machine-readable storage medium of claim 16, wherein the actions with respect to one or more photos include pinning the one or more photos.

18. The non-transitory machine-readable storage medium of claim 16, wherein the actions with respect to one or more photos include spending a particular amount of time viewing the one or more photos.

19. The non-transitory machine-readable storage medium of claim 16, wherein the actions with respect to the one or more photos including viewing the one or more photos a particular number of times.

20. The non-transitory machine-readable storage medium of claim 16, wherein the actions with respect to the one or more photos include sharing the one or more photos.
